(19) United States
(12) Patent Application Publication
(10) Pub. No.: US 2019/0327769 A1
(43) Pub. Date: Oct. 24, 2019

(54) METHOD AND APPARATUS FOR PROCESSING BEAM FAILURE RECOVERY

(71) Applicant: Innovative Technology Lab Co., Ltd., Seoul (KR)

(72) Inventors: Hyosun YANG, Seoul (KR); Kibum KWON, Seoul (KR)

(21) Appl. No.: 16/374,899

(22) Filed: Apr. 4, 2019

(30) Foreign Application Priority Data
Apr. 5, 2018 (KR) 10-2018-0040023
Apr. 13, 2018 (KR) 10-2018-0043350

(51) Int. Cl. H04W 74/08; H04W 72/04; H04B 7/06; H04W 74/02; H04W 56/00; H04W 24/08; H04W 80/02; H04W 76/27

(52) U.S. Cl. CPC H04W 74/0833; H04W 72/046; H04B 7/0695; H04W 76/27; H04W 56/001; H04W 24/08; H04W 80/02; H04W 74/02

(57) ABSTRACT

A method, apparatus, and system for a wireless communication are disclosed. A wireless device may determine a beam failure recovery (BFR) associated with a secondary serving cell (SCell). The wireless device may perform, based on the BFR, a random access procedure for the BFR associated with the SCell. The wireless device may select a random access preamble associated with a synchronization signal block (SSB) of the SCell, stop a first bandwidth part (BWP) inactivity timer associated with the SCell, and run a second BWP inactivity timer associated with a special cell (SpCell). The wireless device may receive, via an active BWP of the SCell, a random access response associated with the random access preamble.

### CROSS-REFERENCE TO RELATED APPLICATIONS

This application claims priority from and the benefit of Korean Patent Application Nos. 10-2018-0040023, filed on Apr. 5, 2018, and 10-2018-0043350, filed on Apr. 13, 2018, each of which is hereby incorporated by reference in its entirety.

### BACKGROUND

### 1. Field

The present disclosure relates to a method and system for performing a beam failure recovery (BFR) in a wireless communication system, and more particularly, to a method and apparatus for performing a BFR based on a type of a servicing cell in a wireless communication system.

### 2. Discussion of the Background

The IMT (International Mobile Telecommunication) frameworks and standards have been developed by ITU (International Telecommunication Union) and, recently, the 5th generation (5G) communication has been discussed through a program called “IMT for 2020 and beyond”.

In order to satisfy requirements from “IMT for 2020 and beyond”, the discussion is in progress about a way for enabling the 3rd Generation Partnership Project (3GPP) New Radio (NR) system to support various numerologies by taking into consideration various scenarios, various service requirements, potential system compatibility. The NR system may perform transmission of a physical signal/channel through a plurality of beams to overcome a poor channel environment. However, a beam failure recovery (BFR) in the NR system may cause an unnecessary signaling overhead and/or an unnecessary battery power waste.

### SUMMARY

Systems, apparatus, and methods are described for wireless communications. A method may comprise: determining, by a wireless device, a beam failure recovery (BFR) associated with a secondary serving cell (SCell); performing, based on the BFR, a random access procedure for the BFR associated with the SCell; and receiving, via an active BWP of the SCell, a random access response associated with the random access preamble. The performing the random access procedure may comprise: selecting a random access preamble associated with a synchronization signal block (SSB) of the SCell; stopping a first bandwidth part (BWP) inactivity timer associated with the SCell; and running a second BWP inactivity timer associated with a special cell (SpCell).

A method may comprise: receiving, by a wireless device and via a secondary serving cell (SCell), a downlink signal; determining, based on the downlink signal, one or more beam failure instances associated with the SCell; performing, based on the one or more beam failure instances, a random access procedure for a beam failure recovery (BFR) associated with the SCell; and monitoring, via an active BWP of the SCell and while running a second BWP inactivity timer associated with a special cell (SpCell), a random access response associated with the random access preamble. The performing the random access procedure may comprise: selecting a random access preamble associated with a candidate beam of the SCell; and stopping a first bandwidth part (BWP) inactivity timer associated with the SCell.

A wireless device may comprise one or more processors and memory. The memory may store instructions that, when executed by the one or more processors, cause the wireless device to: determine a beam failure recovery (BFR) associated with a secondary serving cell (SCell); perform, based on the BFR, a random access procedure for the BFR associated with the SCell; and receive, via an active BWP of the SCell, a random access response associated with the random access preamble. The performing the second random access procedure may comprise selecting a random access preamble associated with a synchronization signal block (SSB) of the SCell; stopping a first bandwidth part (BWP) inactivity timer associated with the SCell; and running a second BWP inactivity timer associated with a special cell (SpCell).

### BRIEF DESCRIPTION OF THE DRAWINGS

Various examples will be described more fully hereinafter with reference to the accompanying drawings. Throughout the drawings and the detailed description, unless otherwise described, the same drawing reference numerals are understood to refer to the same elements, features, and structures. In describing the examples, detailed description on known configurations or functions may be omitted for clarity and conciseness.

FIG. 1 illustrates an example of a wireless communication system.

FIG. 2 illustrates an example of a graph to describe a method of setting a bandwidth part (BWP).

FIG. 3 illustrates an example of a random access procedure.

FIG. 4 is a flowchart illustrating a beam failure recovery (BFR) operation of a user equipment (UE) in response to occurrence of beam failure on a secondary cell (SCell).

FIG. 5 is a flowchart illustrating a method of performing a beam failure recovery.

FIG. 6 is a block diagram illustrating an example of a user equipment (UE) apparatus and an evolved node base (eNodeB) apparatus.

### DETAILED DESCRIPTION

Various examples will be described more fully hereinafter with reference to the accompanying drawings. Throughout the drawings and the detailed description, unless otherwise described, the same drawing reference numerals are understood to refer to the same elements, features, and structures. In describing the examples, detailed description on known configurations or functions may be omitted for clarity and conciseness.

Further, the terms, such as first, second, A, B, (a), (b), and the like may be used herein to describe elements in the description herein. The terms are used to distinguish one element from another element. Thus, the terms do not limit the element, an arrangement order, a sequence or the like. It will be understood that when an element is referred to as being “on”, “connected to” or “coupled to” another element, it can be directly on, connected or coupled to the other element or intervening elements may be present. In contrast, when an element is referred to as being “directly on,” “directly connected to” or “directly coupled to” another element, there are no intervening elements present.

In the described exemplary system, although methods are described based on a flowchart as a series of steps or blocks, aspects of the present disclosure are not limited to the sequence of the steps and a step may be executed in a different order or may be executed in parallel with another step. In addition, it is apparent to those skilled in the art that the steps in the flowchart are not exclusive, and another step may be included or one or more steps of the flowchart may be omitted without affecting the scope of the present disclosure. When an implementation is embodied as software, the described scheme may be embodied as a module (process, function, or the like) that executes the described function. The module may be stored in a memory and may be executed by a processor. The memory may be disposed inside or outside the processor and may be connected to the processor through various well-known means.

Further, the description described herein is related to a wireless communication network, and an operation performed in a wireless communication network may be performed in a process of controlling a network and transmitting data by a system that controls a wireless network, e.g., a base station, or may be performed in a user equipment connected to the wireless communication network.

It is apparent that various operations performed for communication with a terminal in a network including a base station and a plurality of network nodes may be performed by the base station or by other network nodes in addition to the base station. Here, the term ‘base station (BS)’ may be interchangeably used with other terms, for example, a fixed station, a Node B, eNodeB (eNB), gNodeB (gNB), and an access point (AP). Also, the term ‘terminal’ may be interchangeably used with other terms, for example, user equipment (UE), a mobile station (MS), a mobile subscriber station (MSS), a subscriber station (SS), and a non-AP station (non-AP STA).

Herein, transmitting or receiving a channel includes a meaning of transmitting or receiving information or a signal through the corresponding channel. For example, transmitting a control channel indicates transmitting control information or a signal through the control channel. Likewise, transmitting a data channel indicates transmitting data information or a signal through the data channel.

In the following description, a system to which various examples of the present disclosure are applied may be referred to as a New Radio (NR) system to be distinguished from other existing systems. The NR system may include one or more features defined by TS38 series of the third partnership project (3GPP) specification. However, the scope of the present disclosure is not limited thereto or restricted thereby. In addition, although the term ‘NR system’ is used herein as an example of a wireless communication system capable of supporting a variety of subcarrier spacings (SCSs), the term ‘NR system’ is not limited to the wireless communication system for supporting a plurality of subcarrier spacings.

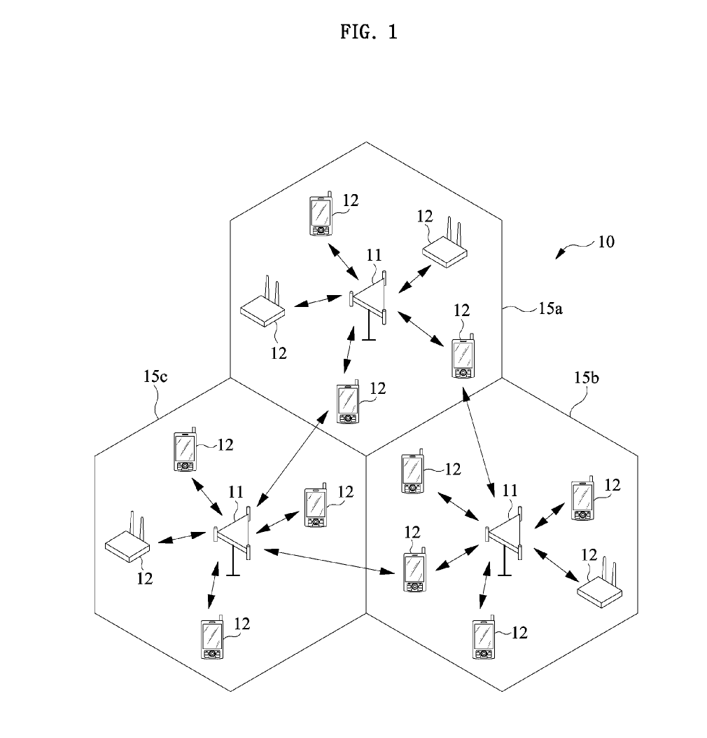

FIG. 1 illustrates an example of a wireless communication system.

Referring to FIG. 1, a network structure may be an Evolved-Universal Mobile Telecommunications System (E-UMTS). The E-UMTS may include at least one of a Long Term Evolution (LTE) system, an LTE-Advanced (LTE-A) system, an LTE-A pro-system, and an evolved-LTE system. Also, the E-UMTS may further include at least one of a 5^{th} generation (5G) mobile communication network, a 5G generation system, and a new ratio (NR) system. That is, the E-UMTS may be a network structure that is configured based on various systems. However, it is provided as an example only and thus, the present disclosure is not limited thereto.

Referring to FIG. 1, in a wireless communication system 10, an evolved node base (eNodeB) 11 and a user equipment (UE) 12 may wirelessly transmit and receive data. Also, the wireless communication system 10 may support device to device (D2D) communication.

In the wireless communication system 10, the eNodeB 11 may provide a communication service to the UE 12 present within coverage of the eNodeB 11 through a specific frequency band. The coverage serviced by the eNodeB 11 may be represented as the term “site”. The site may include a plurality of regions 15a, 15b, and 15c, each also referable as a sector. Each sector included in the site may be identified using a different identifier. Each sector, for example, each of the regions 15a, 15b, and 15c may be understood as a partial region that is covered by the eNodeB 11.

In general, the eNodeB 11 refers to a point, for example, a station, for communication with the UE 12. The eNodeB 11 may be interchangeably used with other terminologies, for example, a base station, an evolved-NodeB (eNodeB), a gNB (g-NodeB or 5G-NodeB), a base transceiver system (BTS), an access point (AP), a femto eNodeB (femto eNodeB), a home eNodeB (HeNodeB), a relay, and a remote radio head (RRH). That is, the eNodeB 11 indicates a communication point with the UE 12 and is not limited to the above example. In the following, the eNodeB 11 is used for convenience of description.

The UE 12 may have fixability or mobility, and may be interchangeably used with other terms, a mobile station (MS), a mobile terminal (MT), a user terminal (UT), a subscriber station (SS), a wireless device, a personal digital assistant (PDA), a wireless modem, a handheld device, a connected car, a wearable device, and an Internet of Things (IoT) device. That is, the UE 12 refers to a device that performs communication and is not limited to the above examples. In the following, the UE 12 is used for convenience of description.

Also, the eNodeB 11 may be interchangeably used with various terms, for example, a megacell, a macrocell, a microcell, a picocell, and a femtocell, depending on a size of coverage provided from the corresponding eNodeB 11 and/or whether a user accessible to the corresponding eNodeB 11 is limited or approved. A cell may be used as a term indicating a frequency band provided from the eNodeB 11, a coverage of the eNodeB 11, a beam configured using an antenna of the eNodeB 11, or the eNodeB 11. Also, when a single UE 12 is simultaneously connected to at least two eNodeBs 11 such as a dual connectivity or a multi connectivity, they may be called using different terms based on a role of each eNodeB 11.

For example, an eNodeB capable of directly transmitting signaling for radio resource control (RRC) over a UE and controlling a mobility and a wireless connection may be referred to as a master eNodeB. Also, an eNodeB capable of providing an additional radio resource to the UE and independently performing a portion of the RRC may be referred to as a secondary eNodeB. That is, the secondary eNodeB may independently perform a portion of the RRC. Here, related partial control information may be performed through the master eNodeB.

Here, the master eNodeB and the secondary eNodeB simply refer to eNodeBs that operate in the aforementioned environment and the present disclosure is not limited thereto. For clarity of description, the master eNodeB and the secondary eNodeB are used.

Also, a downlink (DL) may indicate a communication or a communication path from the eNodeB 11 to the UE 12. An uplink (UL) indicates a communication or a communication path from the UE 12 to the eNodeB 11. In the downlink, a transmitter may be a part of the eNodeB 11 and a receiver may be a part of the UE 12. In the uplink, the transmitter may be a part of the UE 12 and the receiver may be a part of the eNodeB 11.

A multiple access method applied to the wireless communication system 10 may not be particularly limited. Various types of multiple access methods, for example, code division multiple access (CDMA), time division multiple access (TDMA), frequency division multiple access (FDMA), orthogonal frequency division multiple access (OFDMA), signal carrier-FDMA (SC-FDMA), OFDM-FDMA, OFDM-TDMA, OFDM-CDMA, frequency hopping (FH)-CDMA, and FH-OFDMA, may be used. Also, a time division duplex (TDD) method that performs uplink (UL) transmission and downlink (DL) transmission using different times may be used. Also, a frequency division duplex (FDD) method that performs UL transmission and DL transmission using different frequencies may be used. Also, a half-FDD method that performs UL transmission and DL transmission using different frequencies and different times may be used.

The following Table 1 shows abbreviations used herein. Terms shown in Table 1 may be identical to abbreviations used in LTE and LTE-A. Also, in Table 1, gNB refers to an eNodeB of LTE and may be used to be distinguished from eNB. Here, the eNodeB may refer to at least one of the aforementioned gNB and eNB. In the following, the eNodeB is used for clarity of description. However, the following eNodeB may be gNB or eNB and it is provided as an example only and the present disclosure is not limited thereto.

TABLE 1

RRC: Radio Resource Control
MAC: Medium Access Control
RLC: Radio Link Control
PDCP: Packet Data Convergence Protocol
SDAP: Service Data Adaptation Protocol
RAN: Radio Access Network
gNB: g-NodeB
RNTI: Radio Network Temporary Identifier
eMBB: evolved Mobile BroadBand
URLLC: Ultra Reliability Low Latency Communication
mMTC: massive Machine Type Communication
HSS: Home Subscriber Server

Also, a new radio (NR) numerology is described as an NR system. For example, the NR numerology may indicate a numerical value of a default element or factor used to generate a resource grid on a time-frequency domain for design of the NR system. For example, in a numerology of a 3GPP LTE/LTE-A system, a subcarrier spacing may corresponding to 15 kilohertz (kHz). Alternatively, the subcarrier spacing may correspond to 7.5 kHz in a multicast-broadcast single-frequency network (MBSFN). Here, the subcarrier spacing is provided as an example only and the term “numerology” does not limitedly indicate the subcarrier spacing only. The numerology may include at least one of a length of a cyclic prefix (CP) having a correlation with the subcarrier spacing (or determined based on the subcarrier spacing), a transmit time interval (TTI) length, a number of OFDM symbols in a desired time interval, and a duration of a single OFDM symbol. That is, different numerologies may be distinguished from each other when at least one of the subcarrier spacing, the CP length, the TTI length, the number of OFDM symbols in the desired time interval, and the duration of the single OFDM symbol has a different value.

Here, to meet the requirements requested by for example, “IMT for 2020 and beyond”, the 3GPP NR system currently considers a plurality of numerologies based on various scenarios, various service requirements, and compatibility with a potential new system. In detail, a numerology of an existing wireless communication system may not readily support a higher frequency band, a faster movement speed, and a lower delay that are required by “IMT for 2020 and beyond”. Accordingly, there is a need to define a new numerology.

For example, the NR system may support applications, such as enhanced Mobile Broadband (eMBB) considering a ultrawide band, massive Machine Type Communications (mMTC)/ultra Machine Type Communications (MMTC) considering a plurality of lower power apparatuses, and Ultra-Reliable and Low Latency Communications (URLLC) considering low latency. In particular, for example, requirements for user plane latency in an URLLC or eMBB service may be 0.5 ms in uplink. Also, in both uplink and downlink, the requirements may be 4 ms. The requirements relate to a significant latency reduction compared to latency requirements of 10 ms in a 3GPP LTE/LTE-A system.

To meet such various scenarios and various requirements in a single NR system, various numerologies need to be supported. In particular, although a single subcarrier spacing is supported in the existing LTE/LTE-A system, there is a need to support a plurality of subcarrier spacings (SCSs).

A new numerology for the NR system that includes supporting the plurality of SCSs may be applied to solve an issue that a wide bandwidth is unavailable in an existing carrier or frequency range of 700 megahertz (MHz) or 2 gigahertz (GHz). For example, a subcarrier spacing (SCS) may be differently determined with assumption of the wireless communication system that operates in the carrier or the frequency range of 6 GHz or 40 GHz. However, it is provided as an example only and the present disclosure is not limited thereto. That is, in the NR system, a different SCS may be configured depending on a frequency domain being used. As described above, it is provided as an example only.

Also, for example, the NR system considers a transmission using a plurality of beams with respect to a synchronization signal, a random access signal, and a broadcast channel, to overcome a channel environment in which, phase-noise, frequency offset, and path-loss occurring in a high carrier frequency are unfavorable.

Also, the NR system considers a bandwidth part (BWP). For example, when a UE performs transmission and reception of a signal, a frequency bandwidth as wide as a bandwidth of a serving cell may not be required. Here, a bandwidth less than the bandwidth of the service cell may be configured as the BWP. A frequency location of the aforementioned bandwidth may be moved. Also, a bandwidth of an OFDM subcarrier may be changed. It may be defined as a subset of the entire frequency bandwidth of the serving cell, which may be referred to as the bandwidth part (BWP). However, it is provided as an example only and any terms indicating using a bandwidth of a subset may be applied alike.

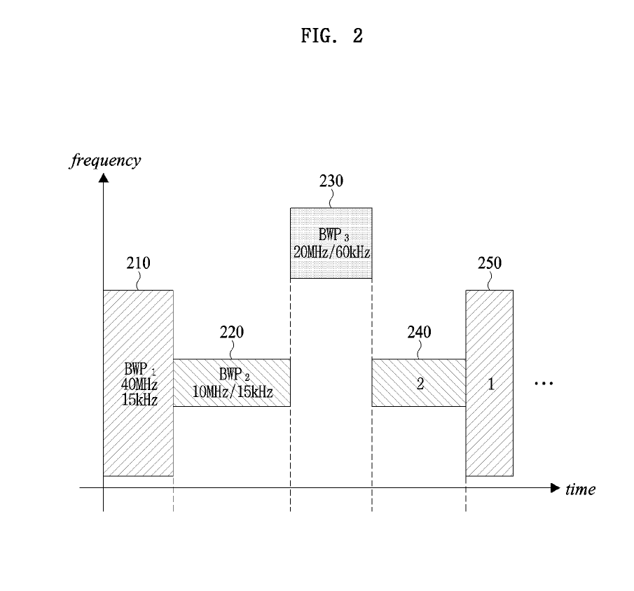

FIG. 2 illustrates an example of a graph to describe a method of setting a BWP. Referring to FIG. 2, for example, a serving cell may include one or more BWPs 210, 220, 230, 240, and 250. Here, with respect to a BWP of the serving cell, an eNodeB may configure information on a plurality of different BWPs in a UE. An uplink BWP and a downlink BWP may be configured as a pair at all times. Therefore, a single piece of BWP configuration information may include configuration information on uplink and downlink at all times. Also, for example, a number of BWPs to be activated among the plurality of BWPs may be limited to one. When the UE is capable of activating at least one BWP, the eNodeB may verify information on a maximum number of activity BWPs of the UE and may simultaneously activate a plurality of BWPs based on the verified information. As another example, when the serving sell is configured in the UE, a single BWP associated with the aforementioned serving cell may be activated without separate signaling from the eNodeB. Here, the UE may perform an initial access to the serving cell and may use the activated BWP for the initial access. Also, an initial BWP may be used until the UE receives UE configuration information from the eNodeB.

When the UE receives the UE configuration information from the eNodeB, a default BWP may be configured in the UE. The default BWP may be set to be a relatively narrow bandwidth. When an amount of data to be transmitted and received is small, the UE may activate the default BWP, thereby reducing a battery consumption of the UE. As another example, when the default BWP is not configured in the UE, the UE may use the initial BWP for the same purpose. That is, the present disclosure is not limited to the aforementioned example.

Also, for example, the activated BWP of the serving cell may be switched to another BWP depending on a situation. This operation may be defined as BWP switching. When the UE performs BWP switching, the UE may inactivate a current activated BWP and may activate a new BWP. Here, the aforementioned BWP switching operation may be performed in response to a BWP switching order that is received at the UE from the eNodeB through physical downlink control channel (PDCCH) order. Also, the aforementioned BWP switching operation may be performed through “BWPInactivityTimer” as a timer for BWP inactivity. Also, the aforementioned BWP switching operation may be performed upon initiation of a random access. Hereinafter, a situation in which the aforementioned BWP switching occurs will be described.

The eNodeB may switch a BWP that is activated on the serving cell of the UE. If the UE desires to switch the activated BWP, the eNodeB may notify the UE of the BWP to be switched through PDCCH. Here, the UE may perform the BWP switching operation based on BWP switching related information included in the PDCCH.

Also, for example, the aforementioned “BWPInactivityTimer” may be configured for each serving cell. Here, “BWPInactivityTimer” may be a timer used to inactivate the activated BWP. This term is provided as an example only. That is, any timer to perform the same functionality may be the aforementioned “BWPInactivityTimer”. Although “BWPInactivityTimer” is used in the following for clarity of description, the present disclosure is not limited thereto.

Here, if the timer expires, the UE may inactivate the current activated BWP and may activate a default BWP. That is, switching to the default BWP may be performed. For example, if the default BWP is not configured in the UE, the UE may switch to the initial BWP. Here, the UE may reduce an amount of battery consumption by monitoring a narrow bandwidth through the aforementioned switching operation. A condition to start and restart the timer may be represented by the following Table 2. Referring to Table 2, if the UE needs to maintain the activated BWP, the timer may be started or restarted to prevent the activated BWP from being inactivated.

TABLE 2
Assign downlink or receive uplink grant based on PDCCH
If a UE receives a downlink assignment or an uplink grant based
on PDCCH order, it indicates that data to be transmitted/received
is present. Thus, a timer may start/restart to maintain a current
activated BWP.
Transmit or receive MAC PDU
When a UE transmits a PAC PDU in a configured uplink grant or
receives the MAC PDU in a configured downlink assignment, the
UE may perform MAC PDU transmission/reception without separately
receiving PDCCH order in the configured uplink grant and the
configured downlink assignment. Therefore, the aforementioned
operation also indicates that data to be transmitted/received is
present and a timer may start/restart to maintain a current
activated BWP.
In the case of performing BWP switching
In the case of performing BWP switching, a timer may start/restart in
a newly switched BWP.

Referring to FIG. 2, for example, at least one of a frequency domain size used in a frequency domain, a subcarrier spacing size, and a length of a time occupied in a time domain of each BWP may be set to be different from those of other BWPs. For example, for each of the BWPs 210, 220, 230, 240, and 250, the frequency band size, the subcarrier spacing size, and the occupancy time length may be set to be different based on BWP configuration information. However, it is provided as an example only and the present disclosure is not limited thereto. Also, a random access resource may be configured for each BWP of the serving cell.

That is, a different random access resource may be configured for each BWP. Therefore, if the UE desires to perform a random access, a situation in which the configured random access resource is absent in a current activated BWP may be considered. Here, for example, the UE may start the random access by autonomously switching to the initial BWP without an instruction from the eNodeB. In detail, as described above, the initial BWP may be set for an initial access and thus, the random access resource may be configured in the initial BWP at all times. Accordingly, when the UE verifies that the random access resource is absent in the activated BWP, the UE may switch to the initial BWP without separate signaling and may perform a random access procedure.

Also, for example, a plurality of beams may be used in the NR system. Here, the aforementioned random access procedure may be performed based on the BWP and the plurality of beams. In the following, the random access procedure in the NR system based on the BWP and the plurality of beams is further described.

For example, the random access procedure refers to a procedure used for the UE to access the eNodeB. Here, the random access may be performed based on a contention-based random access method and a contention-free random access method.

In detail, the contention-based random access method may notify the eNodeB of an access attempt in such a manner that the UE selects a physical random access channel (PRACH) preamble and transmits the selected PRACH preamble to the eNodeB. Upon receiving the PRACH preamble, the eNodeB may generate a random access response (RAR) message and transmit the RAR message to the UE. The RAR message may include a timing advance (TA) value of the UE, a temporary cell-radio network temporary identifier (TC-RNTI) to be used during the random access, and a uplink (UL) grant for uplink transmission of the UE. Upon receiving the RAR message, the UE may perform UL data transmission. Here, when the UE performs the UL data transmission, the UE may include and thereby transmit a cell-RNTI (C-RNTI) or TC-RNTI that is received from the eNodeB. The eNodeB may identify the UE based on the TC-RNTI or the C-RNTI. If the eNodeB completes the identification, the eNodeB may change the TC-RNTI to the C-RNTI. In this manner, the random access procedure may be terminated and the UE may access the eNodeB.

Also, for example, based on the contention-free random access method, the UE may transmit a PRACH preamble using a UE exclusive random access resource received from the eNodeB. Upon receiving the PRACH preamble, the eNodeB may generate a RAR message and may transmit the RAR message to the UE. The UE may receive the RAR message and may verify that the random access procedure is successfully completed. That is, the contention-free random access method may refer to a method that is performed without contention through a designated random access resource.

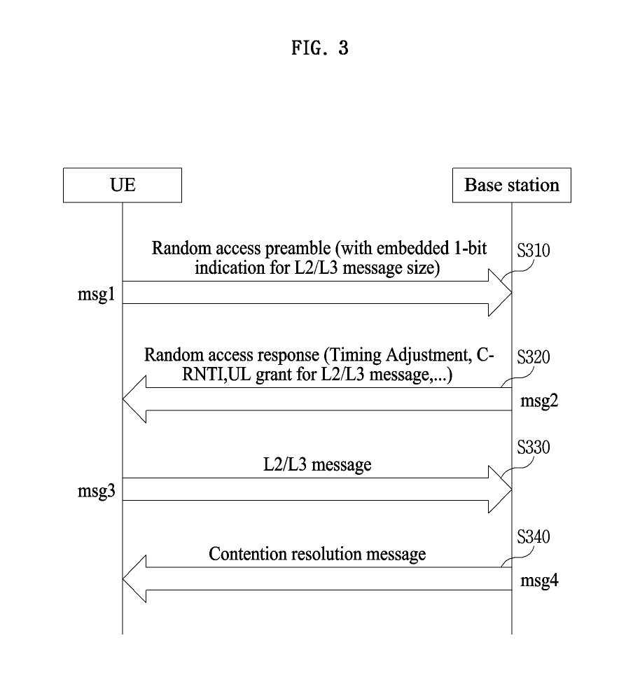

FIG. 3 illustrates an example of a random access procedure. Referring to FIG. 3, in operation S310, a UE may perform random access initialization and then transmit a random access preamble to an eNodeB. Here, for example, the random access initialization may be performed by PDCCH order, a medium access control (MAC) sublayer, a radio resource control (RRC) sublayer, and a beam failure (BF) indication from a physical (PHY) layer. For example, the following Table 4 may relate to a mapping relationship between a detailed cause of a random access and a cause that triggers the random access based on an event.

For example, referring to Table 3, if the UE changes from an idle status to an access status, a regular buffer status report (R-BSR) may be induced based on “RRCConnectionRequest” that requests a network for connection and, for this, the random access procedure may be performed. Also, if the UE loses a radio access, that is, is temporarily wireless disconnected, a transmission of R-BSR transmission may be derived based on “RRCConnectionReestablishmentRequest” as a procedure for reestablishing the radio access. Also, in the case of a handover, the transmission of R-BSR may be requested to transmit an “RRCConnectionReconfigurationComplete” message to a target eNodeB and, for this, the random access may be performed. Also, the random access may be performed based on, for example, a DL transmission procedure, an UL transmission procedure, and a positioning procedure. Also, even in the case of a beam failure, the random access may be performed based on a beam failure indicator. Here, a MAC layer of the UE may receive a beam failure indication from a PHY layer of the UE and, in response thereto, may perform a beam failure recovery (BFR) operation through the random access procedure, which is described below.

TABLE 3

| Event | Initiated by | Note |
|---|---|---|
| initial access from | MAC sublayer | RRCConnectionRequest triggers R-BSR |
| RRC_IDLE | | |
| RRC Connection | MAC sublayer | RRCConnectionReestablishmentRequest triggers R- |
| Reestablishment | | BSR |
| Handover | MAC sublayer | RRCConnectionReconfigurationComplete triggers |
| | | R-BSR |
| DL data arrival | PDCCH order | NW triggers random access |
| UL data arrival | MAC sublayer | New data arrival triggers R-BSR |
| Positioning | PDCCH order | NW triggers random access |
| PSCell management | RRC sublayer | R-BSR triggered by |
| | | RRCConnectionReconfigurationComplete does not |
| | | initiate random access in PSCell |
| STAG management | PDCCH order | NW triggers random access in SCell |
| Beam Failure | Beam Failure | BF indication from a lower layer |
| | indication | |
| On demand SI | MAC sublayer | RRC trigger R-BSR |

Also, a random access procedure on a secondary cell (SCell) excluding a special serving sell (SpCell) in a master cell group (MCG) or a secondary cell group (SCG) may support only a contention-free random access. Here, the random access procedure on the SCell may be ordered by PDCCH. For example, the random access procedure may be performed based on parameters that are preconfigured through RRC signaling. Therefore, information represented by Table 4 may be provided in advance to the UE through RRC signaling.

In detail, the UE may verify a PRACH resource for a preamble transmission based on a “Prach-ConfigIndex” parameter. The UE may determine initial power for a preamble to transmitted based on “ra-PreambleInitialReceivedTargetPower”. The UE may select a related preamble resource and index based on a received signal received power (RSRP) value of a sync signal block (SSB) through an “rsrp-ThresholdSSB” parameter. Also, the UE may select a related preamble resource and index based on an RSRP value of a CSI-RS through a “csirs-dedicatedRACH-Threshold” parameter. Also, the UE may determine an RSRP threshold for an SS block selected based on a “sul-RSRP-Threshold” parameter and a corresponding PRACH resource. Further, the UE may determine a power-ramping factor based on a “ra-PreamblePowerRampingStep” parameter. The UE may determine a random access preamble index based on a “ra-PreambleIndex” parameter and also may determine a maximum number of preamble transmissions based on the “ra-PreambleTx-Max” parameter.

TABLE 4

| Random access parameter | |
|---|---|
| information | Note |
| Prach-ConfigIndex | Set of available PRACH resources for |
| | preamble transmission |
| ra-PreambleInitialReceived | Initial preamble power |
| TargetPower | |
| rsrp-ThresholdSSB | Selection of related preamble resource |
| | and index based on SSB RSRP value |
| csirs-dedicatedRACH-Threshold | Selection of related preamble resource |
| | and index based on CSI-RS RSRP value |
| sul-RSRP-Threshold | RSRP threshold for selection of SS |
| | block and corresponding PRACH |
| | resource |
| ra-PreamblePowerRamping Step | Power-ramping factor |
| ra-PreambleIndex | Random Access Preamble index |
| ra-PreambleTx-Max | Maximum number of preamble |
| | transmissions |

Also, a mapping relationship between each SSB and a preamble transmission resource/index may be preconfigured. Here, a group of preamble indices and indices within the group may be sequentially assigned per SSB depending on whether a mapping relationship between a corresponding SSB and a preamble transmission resource/index is preconfigured.

The aforementioned preamble group may be used for the eNodeB to verify an uplink resource size required for message 3 (msg3) transmission. For example, with the assumption that preamble groups A and B are configured in the UE, if the random access procedure corresponds to a case of at least ra-Msg3 SizeGroupA and a DL pathloss value is less than a value excluding a preamble initial target received power from PCMAC indicating a maximum UE power, the UE may select a preamble index within the group B and perform the random access procedure. Here, the eNodeB may include the aforementioned information in a message 2 (msg2) that is response information to the corresponding preamble and thereby transmit the same through the random access preamble within the group B. That is, information of the uplink resource size required for the msg3 transmission may be included in the msg2 and thereby transmitted to the UE. Here, the msg2 may be a RAR message and the msg3 may be a message that is transmitted in response to the RAR message, which is described below.

Also, for example, a situation in which an SSB is distinguished for each beam may be considered. Here, with the assumption that a mapping relationship between each SSB and a preamble transmission resource/index is preconfigured, if the UE transmits a random access preamble using a specific preamble transmission resource/index, the eNodeB may verify a beam or an SSB that is preferred by the UE. That is, the eNodeB may be aware of information on the preferred beam of the UE by verifying the received random access preamble.

Also, the eNodeB may provide random access information to the UE before performing the random access procedure. For example, referring to Table 5, the eNodeB may provide information on a size of a random access (RA) window to the UE using a number of slots. Also, if necessary, the eNodeB may provide the UE with information on a preamble index set for a system information (SI) request and corresponding PRACH. Also, if necessary, the eNodeB may provide the UE with a beam failure request (BFR) response window and a corresponding PRACH resource.

Also, the eNodeB may provide the UE with information on a size of a contention resolution window through “Ra-ContentionResolutionWindow”. However, they are provided as examples only and the present disclosure is not limited thereto.

TABLE 5

Size of RA window: indicates to the UE with a number of slots
Preamble index set for SI request and corresponding PRACH
resource (if necessary)
Beam failure request response window and corresponding PRACH
resource (if necessary)
Ra-ContentionResolutionWindow: indicates a size of contention
resolution window.

An example of the random access procedure is described above with reference to FIG. 3. As described above, in operation S310, the UE may transmit the random access preamble to the eNodeB. Although the eNodeB is indicated herein for a base station, the aforementioned gNB may also be used. Here, as an example, operation S310 of transmitting the random access preamble may be segmented into a random access initialization and a random access preamble transmission.

In detail, for the random access initialization, the UE may flush a buffer in which the msg3 is included. Here, the UE may set a preamble transmission counter to 1 and may also set a preamble ramping counter to 1. Also, the UE may set a preamble back-off to 0 ms. That is, the UE may perform the initialization operation for the random access preamble transmission.

Subsequently, the UE may perform a carrier selection procedure. In detail, if a carrier on which the random access procedure is to be performed is explicitly signaled, the UE may perform the random access procedure on the corresponding carrier. That is, if the carrier on which the UE is to perform the random access is determined, the UE may perform the random access procedure through the carrier. On the contrary, if the carrier on which the random access procedure is to be performed is not explicitly signaled, a situation in which a supplementary uplink cell (SUL cell) for the random access procedure is set and an RSRP value of DL pathloss of the corresponding cell is less than a sul-RSRP threshold may be considered. In this situation, the UE may select a carrier the SUL cell as a carrier for performing the random access procedure. Also, the UE may perform the random access procedure through the aforementioned carrier by setting a PCMAX value for the SUL cell.

Otherwise, the UE may select a normal carrier as the carrier for performing the random access procedure. In this case, the UE may set a PCMAX value for the normal carrier and may perform the random access procedure through the normal carrier.

Subsequently, the UE may perform a resource selection procedure. Through the resource selection procedure, the UE may set a preamble index value and may determine a related next PRACH occasion. For example, if the PRACH occasion is available, the UE may determine a related next PRACH occasion. In detail, i) if a correlation setting between an SSB index and the PRACH occasion is present, the PRACH occasion may be available. Also, ii) if a correlation setting between CSI-RS and the PRACH occasion is present, the PRACH occasion may be available. Also, iii) if the correlation settings are not provided to the UE in i) and ii), the UE may use a next PRACH occasion.

Here, if the correlation setting between the SSB or the CSI-RS and the PRACH occasion is present, the related PRACH occasion may be determined based on the SSB or the CSI-RS selected by the UE. On the contrary, if the correlation setting is absent, the UE may perform a preamble transmission in the next available PRACH occasion.

The UE may transmit the random access preamble based on the determined PRACH occasion as described above. Here, a MAC layer of the UE may indicate the preamble transmission by providing a selected preamble, a related radio network temporary identifier (RNTI) value, a preamble index, and received target power to a PHY layer. Accordingly, the UE may perform the random access preamble transmission in operation S310.

Here, the eNodeB may receive the random access preamble transmitted from the UE. In operation S320, the eNodeB may transmit a RAR corresponding to the preamble to the UE. That is, the UE may receive the RAR from the eNodeB. Here, the preamble may be msg1 and the RAR may be the msg2 that is a message transmitted from the eNodeB in response to the msg1 (preamble).

The UE may transmit the random access preamble and then start monitoring for reception of the msg2 after a desired symbol (e.g., OFDM symbol). Here, a time section (definable with, for example, a number of slots) in which the UE performs monitoring for reception of msg2 may be a random access (RA) window. Here, a size of the random access window may be provided from the eNodeB to the UE, and may be represented as the above Table 5.

The UE may perform monitoring based on an RA-RNTI value. For example, the UE may monitor at least one of a PDCCH and a PDSCH. In detail, the UE may perform monitoring based on a RA-RNTI in an E-PDCCH included in the PDSCH. Here, the RA-RNTI value may be determined based on a first OFDM symbol index, a first slot index, and a frequency resource index, and a carrier index associated with transmission of the preamble. That is, the RA-RNTI value may be determined based on information associated with a resource used to transmit the preamble.

Here, as an example, if response information is not included in the msg2 received by the UE, the UE may determine that reception of the RAR is a failure and may prepare a retransmission of the random access preamble (msg1). That is, the UE may perform again the preamble resource selection procedure.

On the contrary, if the response information is included in the msg 2 received by the UE, the UE may determine that the reception of the RAR is a success. As another example, if a random access preamble ID is included in the msg2 received by the UE, the UE may determine that the reception of the RAR is a success.

In operation S330, upon succeeding in receiving the RAR, the UE may transmit msg3 to the eNodeB through at least one of scheduling information included in the msg2 and parameter information for msg3 transmission. That is, the msg3 may be a message that is transmitted from the UE successfully receiving the msg2. If the eNodeB successfully receives the msg3, the eNodeB may transmit a contention resolution message (msg4) to the UE in operation S340.

Here, once the msg3 is transmitted, the UE may start a contention resolution timer. The UE may perform monitoring of a PDCCH scrambled with a C-RNTI for receiving the msg4 during an operation of the contention resolution timer.

If the msg4 is received during the operation of the contention resolution timer, the UE may determine that the contention resolution is successfully performed. Accordingly, the UE may perform an initial access.

On the contrary, if the UE fails in receiving the msg2 or performing the contention resolution, the UE may attempt to retransmit the preamble. For example, the UE may determine that the reception of the msg2 is a failure based on the aforementioned description. Also, if the msg4 is not received during the operation of the contention resolution timer, the UE may determine that the contention resolution is a failure. In this case, that is, if the UE fails in receiving the msg2 or the contention resolution, the UE may retransmit the preamble.

As described above, the number of preamble retransmissions may be limited. For example, when the number of preamble retransmissions reaches a desired number of times, for example, a maximum retransmission value defined as “PreambleTransMax” and the UE does not succeed in the initial access, the UE may operate differently based on a type of a serving cell.

For example, if the number of preamble transmissions reaches the maximum retransmission value based on a random access performed by the UE on an SpCell, the UE may report to an upper layer that there is an issue in the random access and may continuously perform the random access. On the contrary, if the number of preamble transmission reaches the maximum retransmission value based on the random access performed by the UE on the SCell, the UE may continuously perform the random access without reporting to the upper layer.

Here, as an example, in a contention-based random access method, all of operations S310 to S340 may be performed. That is, since the UE performs the initial access based on contention with other UEs, the UE may perform all of operations S310 to S340. On the contrary, in a contention-free random access method, the UE may perform only operations S310 and S320 since the UE performs the initial access without contention with the other UEs.

For example, in the contention-free random access method, when the UE determines that the contention resolution is successfully performed, the UE may discard an assigned dedicated random access resource. However, it is provided as an example only and the present disclosure is not limited thereto.

That is, the UE may perform the initial access based on the aforementioned operation. Here, for example, the UE may perform a beam failure recovery (BFR) based on the aforementioned random access operation, which is described below.

For example, when the UE determines that a transmission is a failure with respect to all of the serving beams on a serving cell, the UE may set a new serving beam by discovering the new beam and notifying the eNodeB of the discovered new beam. That is, the aforementioned operation may correspond to the aforementioned beam failure recovery (BFR) operation. Here, the BFR operation may vary based on a type of a serving sell. For example, in an NR system, an SpCell may be configured in a frequency band of 6 GHz or less and an SCell may be configured in a frequency band of 6 GHz or more. However, it is provided as an example only and the present disclosure is not limited thereto. In the NR system, data transmission and reception needs to be guaranteed in each corresponding frequency band on all of the SpCell and the SCell. Accordingly, the BFR may be supported on the SpCell and the SCell. For example, in the current NR system, the BFR may be supported on the SpCell and a single SCell per each MAC entity. However, if the UE is capable of supporting the BFR on at least one SCell, the eNodeB may be configured to support the BFR on a plurality of SCells. Here, to perform the BFR operation, the eNodeB may configure parameters for each serving cell as represented by the following Table 6 and may provide the parameters to the UE.

In detail, a “beamFailureInstanceMaxCount” parameter indicates a maximum count for received beam failure instance indication. Also, a “beamFailureDetectionTimer” parameter indicates a parameter for detecting a beam failure. Also, a “beamFailureCandidateBeamThreshold” parameter may be a parameter indicating an RSRP threshold for beam failure recovery. Also, a “preamblePowerRampingStep” parameter may be a parameter indicating a power ramping step for beam failure recovery. Also, a “preambleReceivedTargetPower” may be a parameter indicating target power for beam failure recovery. Also, a “preambleTxMax” parameter may be a parameter indicating a maximum number of preamble retransmissions. Also, a “ra-ResponseWindow” parameter may be a parameter indicating a time window for monitoring a response to BFR. Also, a “BFR-CORESET” parameter may be a parameter indicating a control resource set for monitoring a response to BFR. Also, a CSI-RS configuration index and/or SS/PBCH index may be indicated. However, they are provided as examples only and the present disclosure is not limited thereto.

TABLE 6
beamFailureInstanceMaxCount: indicates a maximum count for received
beam failure instance indication.
beamFailureDetectionTimer: indicates a beam failure detection timer.
beamFailureCandidateBeamThreshold: indicates an RSRP threshold for
beam failure recovery.
preamblePowerRampingStep: indicates a power ramping step for beam
failure recovery.
preambleReceivedTargetPower: indicates target power for beam failure
recovery.
preambleTxMax: indicates a maximum number of preamble transmissions.
ra-ResponseWindow: indicates a time window for monitoring a response
to BFR.
BFR-CORESET: indicates a control resource set for monitoring a
response to BFR.
CSI-RS configuration index and/or SS/PBCH block index

Also, the UE may set a “BFI_COUNTER” parameter based on the aforementioned parameters. Here, the “BFI_COUNTER” may have an initial value of 0 and may indicate a counter for received beam failure instance indication.

For example, the beam failure recovery (BFR) operation may be initiated through a beam failure detection. That is, in response to detecting the beam failure, the BFR operation may be performed. The UE may detect a failure of a serving beam by measuring a downlink channel environment of serving beams in a PHY layer. For example, the PHY layer may transmit a beam failure instance indication to the MAC layer if the measured downlink channel environment of serving beams is less than a desired threshold. Here, the threshold may have a predetermined error as a value used to determine a beam failure and may be variably set. Upon receiving the beam failure instance indication, the MAC layer of the UE may start a timer called “beamfailuredetectionTimer”. For example, the aforementioned timer may restart every time the beam failure instance indication is received. Also, while the timer operates, the MAC layer may count a consecutively received beam failure instance indication using the “BFI_COUNTER” parameter. Here, if the counter value reaches a maximum value “beamFailureInstanceMaxCounter”, the UE may attempt to perform a beam recovery through the random access procedure. Here, if the beam failure instance indication is not received, the timer “beamfailuredetectionTimer” may expire. If the “beamfailuredetectionTimer” expires, a value of the “BFI_COUNTER” parameter may be initialized to 0. Also, if the MAC layer of the UE performs the random access procedure, the MAC layer may receive candidate beams to which contention-free random access resources are assigned from the PHY layer. For example, the PHY layer may measure a downlink channel environment of candidate beams (e.g., SSB index or CSI-RS configuration index) to which a random access resource for BFR is assigned from the eNodeB. Here, the MAC layer may select a beam satisfying an RSRP threshold defined as “beamFailurecandidateBeamThreshold”, based on the measured downlink channel environment. That is, the beam satisfying the RSRP threshold value may be set as a candidate beam. Here, the candidate beam may be used to select a resource for BFR. The PHY layer may transmit a candidate beam list as a list of the aforementioned candidate beams in response to a request from the MAC layer. In this manner, the candidate beams may be transmitted from the PHY layer to the MAC layer.

On the contrary, if the beam satisfying “beamFailureCandidateBeamThreshold” is absent, the UE may recover the beam failure through a contention-based random access method since there is no available contention-free random access resource. Accordingly, the UE may use both of the contention-free random access method and the contention-based random access method. As described above, the serving cell using both of the contention-free random access method and the contention-based random access method may be limited to the SpCell. For example, the contention-free random access method may be supported on the SCell to support the BFR and the contention-based random access method may not be supported on the SCell.

Hereinafter, an operation of the UE in the case of supporting the contention-free random access for BFR on the SCell considering the aforementioned situation is described.

As described above, the UE may stop “BWPinactivityTimer” upon starting the random access. Accordingly, even when the UE starts the random access for beam failure recovery, “BWPinactivityTimer” may be stopped. Here, a random access resource may be configured for each BWP. Accordingly, if BWP switching is performed during the random access procedure, the UE may need to stop the ongoing random access and preform again the random access on the switched BWP.

In detail, if “BWPinactivityTimer” expires in a situation in which the UE is waiting for receiving a RAR after transmitting a preamble on a current activated BWP, the UE may be switched from the activated BWP to a default BWP or an initial BWP. Here, if the BWP of the UE is changed, a downlink BWP is also changed and the UE may fail in receiving the RAR. That is, the eNodeB may perform RAR transmission through the existing downlink BWP without knowing the BWP switching of the UE and the UE may not receive the RAR. Therefore, to prevent the BWP switching during the random access, the UE may stop “BWPinactivityTimer” when the UE starts the random access.

Hereinafter, an operation of the UE in the case of transmitting a preamble on an SpCell and transmitting the preamble on an SCell is described.

In detail, when a random access event is triggered on the SCell, the UE may expect to receive a random access response (RAR) on the SpCell. For example, the RAR may be transmitted from a common search space of the SpCell and the UE may receive the RAR through monitoring. Therefore, although the random access event is triggered on the SCell, the UE may expect to receive the RAR on the SpCell and accordingly, the UE may stop “BWPinactivityTimer” that operate on all of the SCell and the SpCell.

Hereinafter, a method of performing a beam failure recovery through the contention-free random access method based on the aforementioned operation is described.

As described above, the UE may stop “BWPinactivityTimer”. For example, “BWPinactivityTimer” may be stopped to prevent the BWP from switching to the default BWP or the initial BWP. The UE may stop “BWPinactivityTimer” and then may select a single beam from among candidate beams received from the PHY layer. For example, zero to a maximum of 64 candidate beams may be provided. That is, the PHY layer of the UE may conduct a search for beams, may verify an available beam as a candidate beam, and may notify the MAC layer of the UE of the verified candidate beam. The MAC layer of the UE may select a single beam from among the candidate beams received from the PHY layer, may select a random access resource for the selected beam, and may transmit the selected random access resource to the eNodeB. Here, the random access resource for the selected beam may indicate at least one of a preamble and a time/frequency resource. The UE may wait for receiving a response to the preamble by starting “RA-ResponseWindow” and by monitoring “BFR-CORESET” during an operation of “RA-ResponseWindow”. Here, for example, the eNodeB may recognize that the random access for BFR is performed through the preamble transmitted from the UE.

In detail, as described above, a mapping relationship may be established between the preamble transmitted from the UE and a beam. That is, the eNodeB may verify a beam to be set as a new serving beam based on the received preamble and the mapping relationship. The eNodeB may verify that the random access for BFR is performed and may transmit a C-RNTI scrambled PDCCH as the response to the received preamble.

Here, for example, if the eNodeB transmits the response to the preamble considering BFR, the eNodeB may transmit a PDCCH scrambled with not a RA-RNTI but a C-RNTI. That is, dissimilar to an existing case of transmitting a RAR message through the RA-RNTI scrambled PDCCH, the BFR may be considered. In this case, the eNodeB may transmit the C-RNTI scrambled PDCCH. In the case of considering the BFR, the UE may also perform monitoring with assumption of receiving the C-RNTI scrambled PDCCH.

Also, if the UE does not receive the C-RNTI scrambled PDCCH during an operation of “RA-ResponseWindow”, the UE may reselect a random access resource and may retransmit the preamble. Here, if the number of preamble retransmissions reaches a “preambleTxMax” value, the UE may report to the eNodeB about an issue in a BFR random access. In this case, as an example, the BFR random access issue reporting operation may be performed on all of SpCell and SCell. However, since a point in time at which the UE performs a BEF operation is not known to the eNodeB, the eNodeB may not verify the failure of the UE over the BFR random access. That is, unless the BFR random access issue reporting operation is performed, the eNodeB may not recognize the BFR random access issue and accordingly, such beam failure and data transmission/reception failure may continuously occur in the UE. Dissimilar to the existing random access operation, the UE may report to the eNodeB about the BFR random access issue. In this case, the UE may report to the eNodeB that the random access issue is found on all of SpCell and SCell and, accordingly, the eNodeB may recognize the corresponding random access issue.

On the contrary, if the UE receives the C-RNTI scrambled PDCCH during an operation of “RA-ResponseWindow”, the UE may succeed in beam failure recovery and then may restart the stopped “BWPinactivityTimer”.

Although the UE succeeds in the beam failure recovery, the UE may not discard a UE dedicated random access resource assigned for the BFR. Since the eNodeB is unaware of a point in time at which the UE detects a beam failure and triggers the BFR, the eNodeB may maintain the UE dedicated random access resource assigned for the BFR.

Here, for example, if the UE changes a serving cell through a handover or is switched to be in an idle status, the UE may discard the random access resource. That is, the UE may discard the random access resource through a MAC reset in the aforementioned cases. Further, the UE may discard the random access resource in response to a separate instruction from the eNodeB. However, they are provided as examples only and the present disclosure is not limited thereto.

The aforementioned operation is performed based on the contention-free random access method. Here, a process of performing the BFR based on the contention-based random access method may be identical to the aforementioned contention based random access procedure. That is, if the UE succeeds in receiving the RAR message and the contention resolution, the UE may restart the stopped “BWPinactivityTimer”.

For example, a BFR operation on an SCell may consider only the contention-free random access method. That is, although it is possible to use both the contention-based random access method and the contention-free random access method for the BFR on the SpCell, only the contention-free random access method may be used for the BFR on the SCell. Here, an operation corresponding to a case in which a beam failure is detected on the SCell and there is no available candidate beam may be considered as an example. That is, an operation of the UE in a case in which the contention-free random access method is unavailable on the SCell may be considered.

Here, the UE may consider a beam recovery failure immediately in response to absence of the available candidate beam. That is, if the available candidate beam is absent, the UE may report a BFR random access issue. Also, for example, the UE may discover an available candidate beam and may attempt the contention-free random access method during an operation of a timer that is defined as “beamFailureRecoveryTimer”. Here, if the UE does not discover the available candidate beam until the timer expires, the beam recovery failure may be considered. That is, if the timer expires, the UE may consider this as the beam recovery failure and may report the BFR random access issue. Here, the timer “beamFailureRecoveryTimer” may start at a point in time at which the UE detects the beam failure. Also, as an example, the timer “beamFailureRecoveryTimer” may be stopped when the UE discovers the available candidate beam. Here, if the timer “beamFailureRecoveryTimer” expires, the UE may stop attempting the contention-free random access method.

As another example, although the available candidate beam is absent, the UE may attempt the BFR using a contention-free random access resource. Here, the UE may perform the aforementioned operation for all of the BFR on the SpCell and the BFR on the SCell. In the case of the BFR on the SpCell, the UE may also use the contention-based random access method in response to absence of the available candidate beam. Here, the contention-based random access method may perform the BFR based on contention with other UEs and thus, a collision may occur and an additional delay may occur. On the contrary, in the case of using the contention-free random access resource, the UE may notify the eNodeB of the beam failure immediately without causing the collision.

As another example, in the case of the BFR on the SCell, the UE may not perform the beam recovery if the available candidate beam is absent. Therefore, although an RSRP threshold is not satisfied, the UE may select a candidate beam to which a random access resource is assigned and may notify the eNodeB that the beam failure is detected.

Hereinafter, an operation of the UE for supporting the beam failure recovery on the SCell based on the defined beam failure recovery (BFR) operation is described.

Operation of Supporting Beam Failure Recovery on SCell

If a beam failure is detected on SCell based on the aforementioned examples, the UE may stop only a BWP inactivity timer for the SCell when performing a random access for beam recovery. That is, a BWP inactivity timer for SpCell may not be stopped and only the BWP inactivity timer for the SCell may be stopped.

In detail, in response to the beam failure, the UE may perform a beam recovery operation in the aforementioned manner. Here, a beam failure on a specific SCell may correspond to a case in which the UE receives a beam failure instance indication for the beam failure and a counter value of the beam failure instance indication (BFI_COUNTER) reaches a maximum value “beamFailureInstanceMaxCount” in a state in which the “beamFailureDetectionTimer” does not expire. Here, the UE may initiate a beam failure recovery procedure to recover a beam on the specific SCell in response to the beam failure on the specific SCell.

Here, as described above, the MAC layer of the UE may receive candidate beam information or a candidate beam list from the PHY layer of the UE. Through this, the MAC layer of the UE may verify information on selectable candidate beams. The UE may verify information associated with the candidate beams and may select a secondary candidate beam configured in the MAC layer. Here, the MAC layer of the UE may apply a threshold to select a secondary candidate beam and may configure beams of the threshold or more as secondary candidate beams. The UE may finally select a single beam by arbitrarily selecting a single beam from among the secondary candidate beams or by selecting a beam corresponding to a highest received signal from among the secondary candidate beams. Here, the method is provided as an example only and the UE may select a single beam from among the secondary candidate beams using another method. The UE may select a single beam from a plurality of secondary candidate beams.

Here, as an example, if available secondary candidate beams are absent, the UE may arbitrarily select a single beam from among the candidate beams provided from the PHY layer of the UE. That is, although the MAC layer of the UE may perform, as a default operation, an operation of selecting a single beam from among the secondary candidate beams based on candidate beam information that is provided from the PHY layer, the UE may arbitrarily select a single beam from among the candidate beams provided from the PHY layer of the UE in response to absence of the available secondary candidate beams.

In response to the beam selected through the aforementioned beam selection procedure, the UE may verify parameters associated with a random access procedure that is preconfigured by the eNodeB in the UE for beam failure recovery (BFR) on the specific SCell. Such random access parameters may include information associated with a contention-free random access procedure. For example, as described above, since only the contention-free random access method is applicable on the SCell, only information related thereto may need to be verified on the SCell. For example, the parameters may include configuration information on a random access channel that includes at least one of time and frequency resource information and index information with respect to a random access preamble.

The UE may transmit the random access preamble based on selected beam information through an uplink of the specific SCell by considering parameters associated with the contention-free random access procedure for beam failure recovery corresponding to the selected beam.

Here, the UE may receive a response to the transmitted random access preamble through SpCell within a cell group including the specific SCell or through a downlink of the specific SCell. To receive the response, a control resource set (CORESET) needs to be configured in the UE. The UE may receive the response by monitoring the CORESET during a RAR window. For example, through the response, the UE may verify the beam failure recovery by receiving a C-RNTI scrambled PDCCH secured when establishing RRC connection. Therefore, the UE may need to receive the response to the transmitted random access preamble through all of the SpCell and the specific SCell.

In the meantime, the eNodeB may configure a BWP inactivity timer for each serving cell. Here, if the BWP inactivity timer expires, the UE may be allowed to autonomously switch to a default BWP or an initial BWP, which makes it possible to prevent from unnecessary battery consumption of the UE. However, if the BWP inactivity timer expires on the way in a situation in which the UE needs to wait for receiving a response transmittable from the eNodeB, such as a random access response, during the random access procedure, the UE may switch to the initial BWP and may not receive the response. Accordingly, the UE may prevent inactivation of the current activated BWP and switching to the default BWP or the initial BWP. Here, in a situation in which the UE receives the response to the random access preamble that is transmitted for the beam failure recovery procedure on the specific SCell, the SpCell may not be a serving cell that needs to receive the response. Accordingly, if the UE does not need to perform a data transmission and reception requiring maintaining the current activated BWP on the SpCell, switching to the default BWP or the initial BWP with a minimum bandwidth may need to be allowed. That is, if the UE needs to receive the response to the random access preamble for beam failure recovery on the specific SCell, the UE may stop only the BWP inactivity timer for the specific SCell without stopping the BWP inactivity timer for the SpCell.

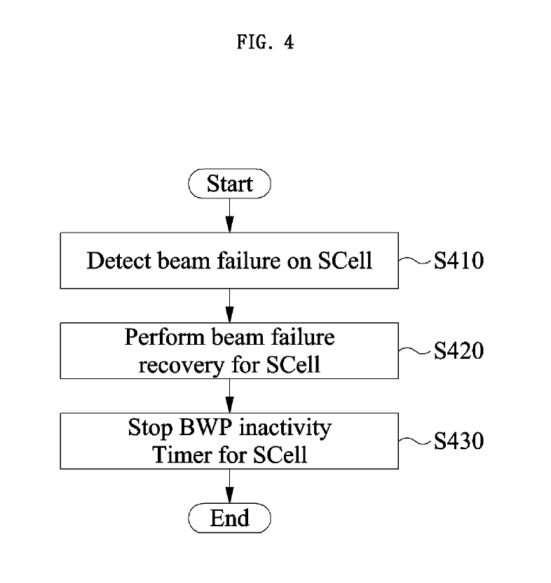

FIG. 4 is a flowchart illustrating beam failure recovery (BFR) operation of a UE in response to occurrence of beam failure on an SCell.

Referring to FIG. 4, in operation S410, the UE may detect the beam failure on the SCell. In operation S420, the UE may initiate a random access procedure to recover the beam failure on the SCell. The UE may stop “BWPinactivityTimer” of the SCell to initiate the random access procedure. That is, the UE may not stop “BWPinactivityTimer” of an SpCell.

In detail, the UE may transmit a preamble to the eNodeB during a process of performing the random access procedure to recover the beam failure on the SCell. Here, the UE may receive a RAR message as a response to the preamble from the eNodeB through an activated BWP of the SCell, regardless of whether the BWP of the SpCell is switched. That is, the UE may prevent BWP switching by stopping the timer for BWP switching on the SCell and may not stop the timer for BWP switching on the SpCell.

For example, only when there is no data transmission and reception requiring maintaining the activated BWP on the SpCell, the UE may not stop the timer for BWP switching on the SpCell. That is, if it is irrelevant whether the activated BWP of the SpCell switches to the default BWP or the initial BWP, the UE may stop the timer to prevent BWP switching on the SCell.

As anther example, only when the UE receives a RAR message through a downlink of a specific SCell based on a contention-free random access procedure, the UE may stop the “BWPinactivityTimer” for the SCell and may not stop the “BWPinactivityTimer” for the SpCell. It is described above.

As another example, only when a BWP is configured for each serving cell and “BWPinactivityTimer” is configured for each serving sell, the UE may stop the “BWPinactivityTimer” for the SCell and may not stop the “BWPinactivityTimer” for the SpCell. For example, when timers for the respective serving cells are simultaneously configured, the timers may be simultaneously stopped.

As another example, when the UE detects a beam failure on the SCell and performs the random access procedure for beam failure recovery, the UE may stop the “BWPinactivityTimer” of the SpCell and may not stop the “BWPinactivityTimer” of the SCell. Here, the UE may receive a RAR message through the BWP of the SpCell and may perform a beam recovery. For example, the SCell and the SpCell on which the beam failure is detected may be included in the same cell group and the UE may receive the RAR message through the SpCell. Here, although this operation relates to recovering the beam failure on the SCell, the UE may perform the beam recovery through the SpCell.

As another example, only when the activated BWP of the SpCell needs to be maintained for data transmission and reception, the UE may receive a RAR message through the activated BWP of the SpCell. Therefore, the UE may perform a beam recovery procedure based on the SpCell without stopping the “BWPinactivityTimer” of the SCell. That is, if the UE maintains the activated BWP of the SpCell due to data transmission and reception, the UE may perform the beam recovery procedure of the SCell through the SpCell.

Here, since the SpCell is used, one of the aforementioned contention-free random access method and contention-based random access method may be applied. However, it is provided as an example only and the present disclosure is not limited thereto.

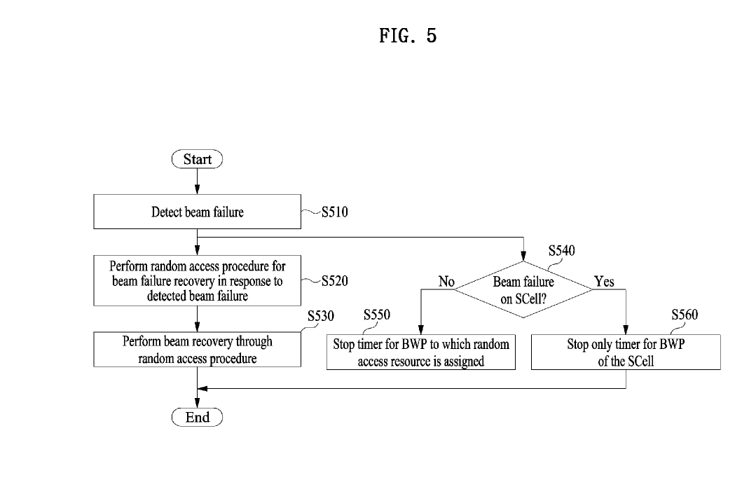

FIG. 5 is a flowchart illustrating a method of performing a beam failure recovery.

Referring to FIG. 5, in operation S510, the UE may detect a beam failure. As described above with reference to FIGS. 1 to 4, the UE may detect a failure of a serving beam by measuring a downlink channel environment of serving beams in a PHY layer. For example, the PHY layer may detect the beam failure by transmitting a beam failure instance indication to a MAC layer if the measured downlink channel environment of serving beams is less than a desired threshold.

In operation S520, the UE may perform a random access procedure for beam failure recovery in response to the detected beam failure. In operation S530, the UE may perform a beam recovery if the random access procedure is successfully completed. Here, as described above with reference to FIGS. 1 to 4, once the beam failure is detected, the UE may perform the beam recovery by performing the random access procedure and may perform the beam failure recovery based on the aforementioned contention-based random access method or contention-free random access method. For example, a random access resource for beam failure recovery (BFR) may be configured for each BWP. Here, in the case of performing the random access as described above, BWP switching may occur in response to expiry of “BWPinactivityTimer”. Accordingly, the BWP switching needs to be prevented. If the UE performs the random access for beam failure recovery, the UE may stop “BWPinactivityTimer” on a BWP to which the random access resource is assigned. In this manner, the UE may prevent the BWP from being switched while performing the random access.

In operation S540, whether the beam failure is a beam failure on an SCell may be determined in response to detecting the beam failure. Here, when the beam failure is not the beam failure on the SCell, the UE may stop a timer for the BWP to which the random access resource is assigned in operation S550. On the contrary, when the beam failure is the beam failure on the SCell, the UE may stop only a timer for the BWP of the SCell among a timer for the BWP of the SpCell and the timer for the BWP of the SCell. That is, the UE may stop only the timer for the BWP of the SCell in operation S560. In detail, as described above with reference to FIGS. 1 to 4, when the UE performs the random access procedure for beam failure recovery, the UE may transmit a preamble to the eNodeB. As a response to the preamble, the UE may receive a random access response (RAR) message from the eNodeB. Here, the UE may receive the RAR message using at least one of the BWP of the SpCell and the BWP of the SCell. Accordingly, in the aforementioned example, the UE may need to prevent BWP switching by stopping all of the timer for the BWP of the SpCell and the timer for the BWP of the SCell. However, since the beam failure corresponds to the beam failure on the SCell, the BWP of the SpCell may not be used. That is, the UE may perform the random access procedure by receiving the RAR message through the BWP of the SCell. Accordingly, the UE may stop only the timer for the BWP of the SCell among the timer for the BWP of the SpCell and the timer for the BWP of the SCell. In this manner, if data to be transmitted and received is absent, the timer for the SpCell may expire and switching to a default BWP or an initial BWP may be performed. That is, the UE may prevent only the BWP of the SCell from being switched. However, it is provided as an example only and the present disclosure is not limited thereto.

A wireless device may establish an RRC connection with a base station. The base station may transmit, to the wireless device, one or more configuration parameters. The one or more configuration parameters may comprise information associated with a BFR and one or more RACH resources for the BFR. The wireless device may determine a BFR associated with a secondary serving cell (SCell). The wireless device may perform, based on the BFR, a random access procedure for the BFR associated with the SCell. The performing the random access procedure may comprise selecting a random access preamble associated with a synchronization signal block (SSB) of the SCell, stopping a first bandwidth part (BWP) inactivity timer associated with the SCell, and running a second BWP inactivity timer associated with a special cell (SpCell). The wireless device may receive, via an active BWP of the SCell, a random access response associated with the random access preamble.

The wireless device may determine an expiration of the second BWP inactivity timer. The wireless device may perform a BWP switching, of the SpCell, from an active BWP of the SpCell to a default BWP of the SpCell or to an initial BWP of the SpCell. The wireless device may monitor, during or after the BWP switching and via the active BWP of the SCell, the random access response. The stopping of the first BWP inactivity timer may prevent a BWP switching of the active BWP of the SCell. The wireless device may determine a second BFR associated with the SpCell, perform, based on the second BFR, a second random access procedure for the second BFR associated with the SpCell. The performing the second random access procedure may comprise selecting a second random access preamble associated with an SSB of the SpCell and stopping the second BWP inactivity timer. The wireless device may receive, via an active BWP of the SpCell, a second random access response associated with the second random access preamble. The SSB may be associated with a candidate beam of the SCell, and the selecting of the random access preamble may indicate a selection of the candidate beam of the SCell for the BFR. The wireless device may determine the BFR by receiving, via a serving beam of the SCell, a downlink signal and determining, based on reference signal received power (RSRP) of the downlink signal, one or more beam failure instances associated with the serving beam of the SCell. The wireless device may determine the BFR by determining that a number of one or more beam failure instances satisfies beamFailureInstanceMaxCount. The random access response may be scrambled based on a cell radio network temporary identifier (C-RNTI). The wireless device may determine, based on the random access response, the BFR is successful. The wireless device may restart, based on the determining that the BFR is successful, the stopped first BWP inactivity timer.

A wireless device may receive, via a secondary serving cell (SCell), a downlink signal, determine, based on the downlink signal, one or more beam failure instances associated with the SCell, and perform, based on the one or more beam failure instances, a random access procedure for a beam failure recovery (BFR) associated with the SCell. The performing the random access procedure may comprise selecting a random access preamble associated with a candidate beam of the SCell and stopping a first bandwidth part (BWP) inactivity timer associated with the SCell. The wireless device may monitor, via an active BWP of the SCell and while running a second BWP inactivity timer associated with a special cell (SpCell), a random access response associated with the random access preamble. The wireless device may determine, while monitoring the random access response, an expiration of the second BWP inactivity timer associated with the SpCell. The wireless device may perform, based on the expiration, a BWP switching, of the SpCell, from an active BWP of the SpCell to a default BWP of the SpCell or to an initial BWP of the SpCell.

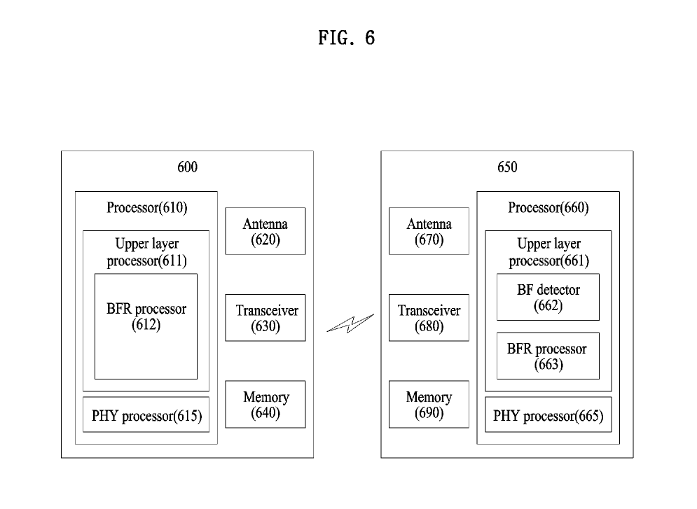

FIG. 6 is a block diagram illustrating a UE and an eNode B.

Referring to FIG. 6, a base station device 600 may include a processor 610, an antenna 620, a transceiver 630, and a memory 640.

The processor 610 may perform baseband-related signal processing and may include an upper layer processor 611 and a physical (PHY) layer processor 615. The upper layer processor 611 may process an operation of a Medium Access Control (MAC) layer, a Radio Resource Control (RRC) layer, or more upper layer. The PHY layer processor 615 may process an operation (e.g., uplink (UL) received signal processing and downlink (DL) transmission signal processing) of a PHY layer. The processor 610 may control the overall operation of the base station device 600 in addition to performing the baseband-related signal processing.

The antenna 620 may include at least one physical antenna. If the antenna 620 includes a plurality of antennas, multiple input multiple output (MIMO) transmission and reception may be supported. The transceiver 630 may include a radio frequency (RF) transmitter and an RF receiver. The memory 640 may store operated information of the processor 610 and software, an operating system (OS), an application, etc., associated with an operation of the base station device 600, and may include a component, for example, a buffer.

The processor 610 of the base station device 600 may be configured to implement an operation of a base station disclosed herein. The upper layer processor 611 in the processor 610 of the base station device 600 may include the BFR processor 612. The BFR processor 612 may solve the BFR issue by reconfiguring a beam of the SCell upon receiving a report about occurrence of BFR on the SCell.

Referring again to FIG. 6, a terminal device 650 may include a processor 660, an antenna 670, a transceiver 680, and a memory 690.

The processor 660 may perform baseband-related signal processing and may include an upper layer processor 661 and a PHY layer processor 665. The upper layer processor 661 may process an operation of a MAC layer, an RRC layer, or more upper layer. The PHY layer processor 665 may process an operation (e.g., UL received signal processing and DL transmission signal processing) of a PHY layer. The processor 660 may also control the overall operation of the terminal device 650 in addition to performing baseband-related signal processing.

The antenna 670 may include at least one physical antenna. If the antenna 670 includes a plurality of antennas, MIMO transmission and reception may be supported. The transceiver 680 may include an RF transmitter and an RF receiver. The memory 690 may store operated information of the processor 660 and software, an OS, an application, etc., associated with an operation of the terminal device 650, and may include a component, for example, a buffer.

The processor 660 of the terminal device 650 may be configured to implement an operation of a terminal disclosed herein. The upper layer processor 661 and the PHY layer processor 665 in the processor 660 of the base station device 650 may include the BF detector 662 and the BFR processor 663.

The BF detector 662 may determine occurrence of a beam failure by measuring a downlink channel environment. Also, the BF detector 662 may notify the upper layer processor 661 of the occurrence of the beam failure depending on a cell on which the beam failure occurs. In response thereto, the upper layer processor 661 may inform the BFR processor 663 to initiate a random access procedure.

The processors may include an application-specific integrated circuit (ASIC), another chipset, a logic circuit, and/or a data processing device. The memories may include a Read-Only Memory (ROM), a Random Access Memory (RAM), a flash memory, a memory card, a storage medium and/or another storage device. The RF units may include a baseband circuit for processing a wireless signal. When an embodiment is embodied as software, the described scheme may be embodied as a module (process, function, or the like) that executes the described function. The module may be stored in a memory, and may be executed by a processor. The memory may be disposed inside or outside the processor, and may be connected to the processor through various well-known means.

In the described exemplary system, although methods are described based on a flowchart as a series of steps or blocks, aspects are not limited to the sequence of the steps and a step may be executed in a different order or may be executed in parallel with another step. In addition, it is apparent to those skilled in the art that the steps in the flowchart are not exclusive, and another step may be included or one or more steps of the flowchart may be omitted without affecting the scope of the present disclosure.

What is claimed is:

1. A method comprising:
determining, by a wireless device, a beam failure recovery (BFR) associated with a secondary serving cell (SCell);
performing, based on the BFR, a random access procedure for the BFR associated with the SCell, wherein performing the random access procedure comprises:
selecting a random access preamble associated with a synchronization signal block (SSB) of the SCell;
stopping a first bandwidth part (BWP) inactivity timer associated with the SCell; and
running a second BWP inactivity timer associated with a special cell (SpCell); and
receiving, via an active BWP of the SCell, a random access response associated with the random access preamble.

2. The method of claim 1, further comprising:
determining an expiration of the second BWP inactivity timer;
performing a BWP switching, of the SpCell, from an active BWP of the SpCell to a default BWP of the SpCell or to an initial BWP of the SpCell; and
monitoring, during or after the BWP switching and via the active BWP of the SCell, the random access response.

3. The method of claim 1, wherein the stopping of the first BWP inactivity timer prevents a BWP switching of the active BWP of the SCell.

4. The method of claim 1, further comprising:
determining, by the wireless device, a second BFR associated with the SpCell;
performing, based on the second BFR, a second random access procedure for the second BFR associated with the SpCell, wherein performing the second random access procedure comprises:
selecting a second random access preamble associated with an SSB of the SpCell; and
stopping the second BWP inactivity timer; and
receiving, via an active BWP of the SpCell, a second random access response associated with the second random access preamble.

5. The method of claim 1, wherein the SSB is associated with a candidate beam of the SCell, and wherein the selecting of the random access preamble indicates a selection of the candidate beam of the SCell for the BFR.

6. The method of claim 1, wherein the determining the BFR comprises:
receiving, via a serving beam of the SCell, a downlink signal; and
determining, based on reference signal received power (RSRP) of the downlink signal, one or more beam failure instances associated with the serving beam of the SCell.

7. The method of claim 1, wherein the determining the BFR comprises determining that a number of one or more beam failure instances satisfies beamFailureInstanceMaxCount.

8. The method of claim 1, wherein the random access response is scrambled based on a cell radio network temporary identifier (C-RNTI).

9. The method of claim 1, further comprising:
determining, based on the random access response, that the BFR is successful; and
restarting, based on the determining that the BFR is successful, the stopped first BWP inactivity timer.

10. A method comprising:
receiving, by a wireless device and via a secondary serving cell (SCell), a downlink signal;
determining, based on the downlink signal, one or more beam failure instances associated with the SCell;
performing, based on the one or more beam failure instances, a random access procedure for a beam failure recovery (BFR) associated with the SCell, wherein the performing the random access procedure comprises:
selecting a random access preamble associated with a candidate beam of the SCell; and
stopping a first bandwidth part (BWP) inactivity timer associated with the SCell; and
monitoring, via an active BWP of the SCell and while running a second BWP inactivity timer associated with a special cell (SpCell), a random access response associated with the random access preamble.

11. The method of claim 10, further comprising:
determining, while monitoring the random access response, an expiration of the second BWP inactivity timer associated with the SpCell; and
performing, based on the expiration, a BWP switching, of the SpCell, from an active BWP of the SpCell to a default BWP of the SpCell or to an initial BWP of the SpCell.

12. The method of claim 10, wherein the stopping of the first BWP inactivity timer prevents a BWP switching of the active BWP of the SCell.

13. The method of claim 10, further comprising:
determining, by the wireless device, a second BFR associated with the SpCell;
performing, based on the second BFR, a second random access procedure for the second BFR associated with the SpCell, wherein performing the second random access procedure comprises:
selecting a second random access preamble associated with a candidate beam of the SpCell; and
stopping the second BWP inactivity timer; and
receiving, via an active BWP of the SpCell, a second random access response associated with the second random access preamble.

14. The method of claim 10, wherein the selecting of the random access preamble indicates a selection of the candidate beam of the SCell for the BFR.

15. A wireless device comprising:
one or more processors; and
memory storing instructions that, when executed by the one or more processors, cause the wireless device to:
determine a beam failure recovery (BFR) associated with a secondary serving cell (SCell);
perform, based on the BFR, a random access procedure for the BFR associated with the SCell, wherein performing the random access procedure comprises:
selecting a random access preamble associated with a synchronization signal block (SSB) of the SCell;
stopping a first bandwidth part (BWP) inactivity timer associated with the SCell; and
running a second BWP inactivity timer associated with a special cell (SpCell); and
receive, via an active BWP of the SCell, a random access response associated with the random access preamble.

16. The wireless device of claim 15, wherein the instructions, when executed by the one or more processors, cause the wireless device to:
determine an expiration of the second BWP inactivity timer;
perform a BWP switching, of the SpCell, from an active BWP of the SpCell to a default BWP of the SpCell or to an initial BWP of the SpCell; and
monitor, during or after the BWP switching and via the active BWP of the SCell, the random access response.

17. The wireless device of claim 15, wherein the stopping of the first BWP inactivity timer prevents a BWP switching of the active BWP of the SCell.

18. The wireless device of claim 15, wherein the instructions, when executed by the one or more processors, cause the wireless device to:
determine a second BFR associated with the SpCell;
perform, based on the second BFR, a second random access procedure for the second BFR associated with the SpCell, wherein performing the second random access procedure comprises:
selecting a second random access preamble associated with an SSB of the SpCell; and
stopping the second BWP inactivity timer; and
receive, via an active BWP of the SpCell, a second random access response associated with the second random access preamble.

19. The wireless device of claim 15, wherein the SSB is associated with a candidate beam of the SCell, and wherein the selecting of the random access preamble indicates a selection of the candidate beam of the SCell for the BFR.

20. The wireless device of claim 15, wherein instructions, when executed by the one or more processors, cause the wireless device to determine the BFR by:
receiving, via a serving beam of the SCell, a downlink signal; and
determining, based on reference signal received power (RSRP) of the downlink signal, one or more beam failure instances associated with the serving beam of the SCell.
